(19) United States
(12) Patent Application Publication
(10) Pub. No.: US 2004/0028868 A1
(43) Pub. Date: Feb. 12, 2004

(54) Ceramic tile armour

(76) Inventor: Brynley Jonathan James, Salisbury (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/399,841

(22) PCT Filed: Oct. 26, 2001
(86) PCT No.: PCT/GB01/04732

(51) Int. Cl. B32B 3/14

(52) U.S. Cl. 428/49

(57) ABSTRACT

A ceramic tile armour system in which each tile (1) has one or more of its side faces (34) cut at an angle to the main faces (12) of the tile, adjacent tiles being arranged such that the angled faces thereof fit together to provide one or more overlapping joints between the tiles. Preferably the side faces are angled at between 30 deg. and 60 deg., preferably at 45°, with respect to the main faces of each tile.

The present invention relates to ceramic tile armour systems and in particular to tile shaping of the tiles in such systems. By the term “tile” used herein is meant a relatively thin and substantially planar object having two principal faces lying in planes that are substantially parallel, said faces being joined together by at least three and usually four, side or peripheral faces which are small in relation to the areas of the principal faces. Such tiles will be generally rectangular in outline and may be square and the following description is directed to tiles of this shape. However it is to be appreciated that this invention is equally applicable to tiles which have more or less than four peripheral faces (ie. edges).

Many modern armour systems which are designed to assist in the defeat of armour piercing (AP) ammunition, rely on the use of a plurality of separate tiles of a hard ceramic material fixed to a ductile backing material (such as an aluminium alloy) rather than using a single (or relatively few) sheets of armour material. By making the tiles relatively small in area, impact by an AP round leads to damage to only a single or relatively few tiles thus enhancing tile multi-hit capability of the armour protection on, say, a vehicle or tank. However, this approach does have the disadvantage that, because the tiles tend to suffer more damage in regions towards their edges, there is a limit to how much the area of the individual tiles can be reduced without seriously compromising the overall ballistic efficiency of the tile armour fitted to a vehicle or the like.

Traditionally the method of minimising this problem has been to use tiles of sufficient thickness such that even those areas of each tile which are close to its edges have met the desired performance level for the armour as a whole. However, the consequence of such over-specification is that the armour system for a vehicle or the like becomes heavier than it would be were the ballistic performance uniform over the entire area of each tile. For many applications, particularly in regard to armour protection for moving targets, this is very undesirable because weight is always a critical factor with equipments.

It is an object of the present invention therefore to provide a ceramic tile armour which has a greater efficiency ballistic performance, ie. which will gives better performance overall for a given weight (or thickness) of ceramic material.

Accordingly the present invention provides a ceramic tile armour configuration in which adjacent tiles in the configuration are overlapped within the thickness of the tiles, that is to say that the side or peripheral faces do not lie perpendicular to the principal faces but are angled with respect thereto and the peripheral faces of adjacent tiles are correspondingly angled so as to provide the desired overlap of the side face of one tile with the adjacent side face of the next tile in the configuration.

In one arrangement one side face of a tile may be set at a particular angle with respect to one principal face of the tile and the opposing side face is set at the same angle with respect to the other principal face of the tile. By lining up such tiles end to end a linear overlapping configuration will be obtained.

However, most conveniently, by chamferring two contiguous peripheral faces of each tile at an angle with respect to one of the principal races and the other two peripheral races at the same or a similar angle with respect to the other principal face, a complete armour configuration may be built up by placing appropriate edges of adjacent tiles in overlapping interrelationship with each other. In this way the majority of the tiles used within a particular configuration can be of the same geometry excepting of course any tiles which lie at the edges of the configuration or in any other location where at non-angled side face is preferred or required such as adjacent to a discontinuity in the vehicle surface, eg. an aperture or a projection on the surface. In such circumstances also it will be appreciated that it could be convenient to use it tile which has more or less than four peripheral sides).

It will, however, be readily understood that other combinations of angled sides may be adopted as is convenient or appropriate to the shape of the structure which is to be covered thereby and that all such combinations are contemplated as being within the scope of this invention.

Whereas, in a typical armour configuration, in which the tiles are butt jointed, the ballistic performance of a tile of 8.6 mm thickness has been found to be degraded to that of a tile only 6 mm in thickness for impacts at or near to the tile edge, it has been found that, using tiles shaped in accordance with the present invention there is virtually no degradation of performance at or near the tile edges. Consequently the ballistic performance of a tile configuration using 6 mm thick tiles with all of the peripheral faces in overlapping relationship according to this invention, is almost as good as the conventional configuration in which the tiles are butt jointed and of 8.6 mm thickness. However, the former configuration weighs only some 70% of the latter, which represents an extremely advantageous result.

A further advantage of the tile system according to the present invention is that by angling the joint between the tiles with respect to tile principal faces thereof, a greater resistance is caused to the passage of a jet of material through the joint between adjacent tiles. In conventional, butt-jointed, tile systems, should the armour be struck by a soft lead round (ball round) for instance the lead could be jetted through the small gap between adjacent tiles, especially in the event that the the joint is not well tolerenced. In the case of tiles of the present invention the angled joint and the fact that the path through or along the joint is also longer means that there is more resistance to penetration by jets deriving from ball rounds or the like.

Preferably the angled edge faces of ceramic armour tiles according to this invention are set at an angle of between 30″ and 60″ to the principal faces of the tile, most preferably at an angle of about 45″ thereto.

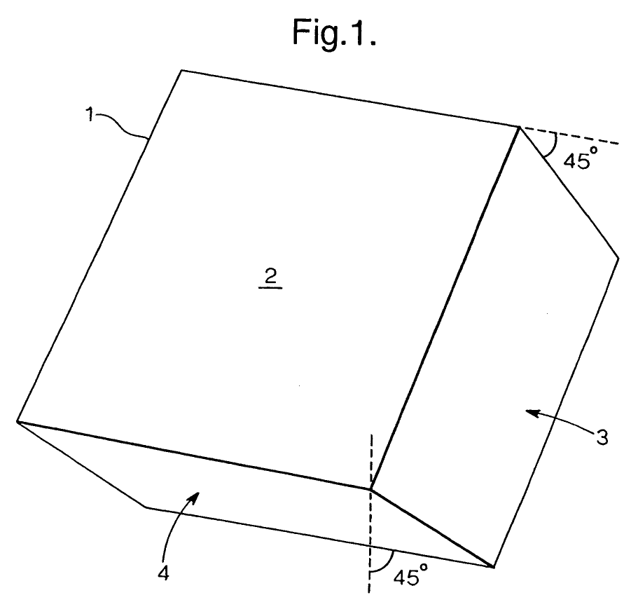

The invention will now be further described with reference to the accompanying drawing (FIG. 1). In the drawing a ceramic armour tile is shown generally at 1. One of the principal faces of the tile is shown at 2 and a first side face at 3. This side face of the tile is chamferred at an angle of the order of 45″ with respect to principal face 2 as shown and thus this side face projects beyond the upper tile surface as shown in this drawing. A second side face is shown at 4 and this time is undercut with respect to the principal face 2 of the tile, but again at a similar angle. Similarly those side faces which lie on opposite sides of the tile to the faces shown at 3 and 4 may be angled in a corresponding manner. It will be readily appreciated that a number of such tiles may be brought into close proximity in a manner such that there is overlap between the proximate side faces of the tiles and that in particular a single tile of the type illustrated may have four corresponding tiles placed adjacently thereto with all of the four joints between these tiles and the central tile being co-operatively angled to give overlapping joints on all sides of the central tile. In this way it will be appreciated that a large area of a structure to be protected may be covered with tiles, all the edges of which overlap with the proximate edges of other adjacent tiles.

The required angling of the tile edges can be effected readily in the manufacture of the tiles by pressing or by slip casting or by machining of the tired tile. Pressing of slip casting are to be preferred for reasons of cost.

1. A ceramic tile (as herein defined) for use in an armour configuration, in which at least one side face thereof is set at an angle to the principal faces thereof, said angle being substantially different to 90°.

2. A ceramic tile as claimed in claim 1 wherein the angle with respect to one of the principal faces is between 30° and 60°.

3. A ceramic tile as claimed in claim 1 or claim 2 wherein one side face is set at an angle of between 30° and 60° with respect to one principal face and another side face is set at an angle of between 30° and 60° with respect to the other principal face of the tile.

4. A ceramic tile as claimed in claim 3 wherein the angled side faces are disposed on opposite sides of the tile.

5. A ceramic tile as claimed in claim 1 or claim 2 which is rectangular in plan and wherein two of its side faces are set at an angle of between 30° and 60° with respect to one principal face of the tile and the other two side faces are set at an angle of between 30° and 60° with respect to the other principal face of the tile.

6. A ceramic tile as claimed in claim 5 wherein the side faces in each pair of such faces are contiguous one with the other.

7. A ceramic tile as claimed in claim 5 wherein the side faces in each pair of such faces lie on opposite sides of the tile.

8. A ceramic tile as claimed in any of claims 1 to 4 wherein the angle is about 45″.

9. An armour configuration comprising a plurality of tiles as claimed in any of claims 1 to 8 and wherein tiles having oppositely angled side faces are so arranged that such side faces are proximate to each other so as to provide overlapping joints between adjacent tiles along those sides.

10. A ceramic tile substantially as shown in the accompanying drawing.
